(19) United States
(12) Patent Application Publication
(10) Pub. No.: US 2006/0281846 A1
(43) Pub. Date: Dec. 14, 2006

(54) Laser-weldable which are transparently, translucently, or opaquely dyed by means of colorants

(75) Inventors: Harald Hager, Freigericht (DE); Thomas Hasskerl, Kronberg (DE); Gunther Ittmann, Grob-Umstadt (DE); Roland Wursche, Dulmen (DE); Klaus-Dieter Schubel, Recklinghausen (DE)

Correspondence Address: FITCH, EVEN, TABIN & FLANNERY, P. O. BOX 18415, WASHINGTON, DC, 20036, US

(73) Assignee: Degussa AG, Dusseldorf (DE)

(21) Appl. No.: 10/544,041

(22) PCT Filed: Feb. 18, 2005
(86) PCT No.: PCT/EP05/01687

§ 371 Date: Aug. 2, 2005

(30) Foreign Application Priority Data
Mar. 4, 2004 (DE) 202004003362.3
Oct. 22, 2004 (DE) 102004051457.7

(51) Int. Cl. C08K 3/22

(52) U.S. Cl. 524/430; 524/408; 524/424; 524/423

(57) ABSTRACT

The present invention relates to transparent, translucent, or opaque plastic materials that are tinted due to colorants, which are laser-weldable due to a content of nanoscale laser-sensitive particles. These plastic materials, which may be provided as molded bodies, semifinished products, or lacquer coatings, particularly contain laser-sensitive particles with a particle size from 5 to 100 nm and a content from 0.0001 to 0.1 weight had percent. Typical compounds are nanoscale indium-tin oxide, antimony-tin oxide, indium-zinc oxide, and lanthanum hexaboride.

The present invention relates to transparent, translucent, opaque plastic materials that are tinted by colorants, which are laser-weldable due to a content of nanoscale laser-sensitive particles, as well as a method for manufacturing plastic materials of this type and their use.

The welding of plastic parts using laser energy is known per se. The laser weldability is caused by absorption of the laser energy in the plastic material, either directly through interaction with the polymer or indirectly using a laser-sensitive agent added to the plastic material. The laser-sensitive agent may be an organic colorant or a pigment which causes a local heating of the plastic through absorption of the laser energy. In laser welding, the plastic material is so strongly heated in the join region through absorption of the laser energy that the material melts and both parts are welded to one another.

In practice, the principle of composite formation between join partners in laser welding is based on a join partner facing toward the laser source having sufficient transparency for the light of the laser source, which has a specific wavelength, so that the radiation reaches the join partner lying underneath, where it is absorbed. Because of this absorption, heat is released, so that in the contact region of the join partners, not only the absorbing material, but rather also the transparent material melt locally and partially mix, through which a composite is produced after cooling. Both parts are welded to one another in this way as a result.

The laser weldability is a function of the nature of the plastic materials and/or the polymers which they are based on, of the nature and content of any laser-sensitive additives, and of the wavelength and radiation power of the laser used. In addition to CO₂ and Excimer lasers, Nd:YAG lasers (neodymium-doped yttrium-aluminum-garnet lasers), having the characteristic wavelengths 1064 nm and 532 nm, are increasingly used in this technology, and more recently even diode lasers.

Laser-weldable plastic materials, which contain laser-sensitive additives in the form of colorants and/or pigments, generally have a more or less pronounced coloration and/or intransparency. In the case of laser welding, the molding compound to be made laser-absorbent is most frequently thus equipped by introducing carbon black.

A method for laser-welding of plastic molded parts, the laser beam being conducted through a laser-transparent molded part I and causing heating in a laser-absorbent molded part II, through which the welding occurs, is described in DE 10054859 A1. The molded parts contain laser-transparent and laser-absorbent colorants and pigments, particularly carbon black, which are tailored to one another in such a way that a homogeneous color impression arises. The material is not naturally transparent. Since carbon black causes a strong black coloration even at low concentration, only dark colors or gray tones may be implemented for the product. Furthermore, it is currently possible to weld transparent and/or laser-transparent materials onto opaque tinted materials.

In principle, according to the teaching of DE 10054859 A1, the laser-transparent join partner and the laser-absorbent join partner may be set in the same tone. However, completely different colorants are necessary for this purpose. One skilled in the art is advised to perform tests in this case.

Identical color settings of this type using different colorants typically have different aging behaviors under environmental influence, so that different color changes result in use and in the course of time.

The joining, through laser welding, of two plastic components having the color setting white/white, identical color/identical color, especially light color settings being difficult, or transparent on white or light color settings is possible only unsatisfactorily, with difficulty, or not at all using laser welding. Therefore, there is a need for plastic materials of the combinations cited which may be joined through laser welding.

Transparent-colored, translucent-colored, and opaque-tinted laser-weldable plastic materials having precisely defined, freely selectable colors, particularly those which are additionally resistant to weather and aging, are not known from the related art.

The present invention is therefore based on the object of providing transparent, translucent, or opaque laser-weldable plastic materials that are tinted by colorants—particularly those having light color tones. For this purpose, laser-sensitive additives for plastic materials are to be found, using which they may be made laser-weldable without the transparency and/or the color of the material being impaired.

The present invention describes plastic materials that contain a laser-sensitive additive which does not influence the intrinsic color of the plastic. This applies both to the coloring and to the aging behavior. The plastic materials are basically equipped with colorants and/or pigments, which are laser-transparent per se, to set the desired color and/or opacity. For the purposes of laser welding, the laser-absorbent join partner made of this plastic material contains the laser-sensitive additive.

Surprisingly, it has been found that transparent, translucent, or opaque laser-weldable plastic materials that are tinted by colorants may be made laser-markable and/or laser-weldable due to a content of nanoscale laser-sensitive particulate fillers, without the color and/or the transparency being impaired.

The object of the present invention is therefore transparent, translucent, or opaque laser-weldable plastic materials that are tinted by colorants, which are distinguished in that they are laser-weldable due to a content of nanoscale laser-sensitive particles.

Furthermore, the object of the present invention is the use of nanoscale laser-sensitive particles to manufacture transparent, translucent, or opaque laser-weldable plastic materials that are tinted by colorants.

In addition, the object of the present invention is a method for manufacturing transparent, translucent, or opaque laser-weldable plastic materials that are tinted by colorants with the aid of nanoscale laser-sensitive particles, the particles being incorporated into the plastic matrix with high shear.

The present invention is based on the recognition that the laser marking pigments known from the related art are not suitable for high-transparency systems in regard to their particle size and their morphology, since they typically significantly exceed the critical size of a fourth of the wavelength of visible light of approximately 80 nm. Laser-sensitive pigments having primary particles below 80 nm particle size are known, but these are not provided in the form of isolated primary particles or small aggregates, but rather, as in the case of carbon black, for example, are only available as highly aggregated, partially agglomerated particles having a significantly larger particle diameter. The known laser marking pigments therefore lead to significant scattering of the light and therefore to clouding of the plastic material.

Furthermore, the present invention is based on the recognition that the laser marking pigments known from the related art elevate the turbidity of the material, corrupt the color of the material, and make color corrections necessary due to their intrinsic color and their insufficient dispersability, the color corrections not succeeding satisfactorily and deviations from the desired color having to be accepted.

According to the present invention, nanoscale laser-sensitive particulate additives are added to the plastic materials, particularly those which have transparency or translucency per se, and which are otherwise tinted colored, white, or opaque, in order to make them laser-weldable.

Laser-sensitive nanoscale particulate additives are to be understood as all inorganic solids, such as metal oxides, mixed metal oxides, complex oxides, metal sulfides, borides, phosphates, carbonates, sulfates, nitrides, etc., and/or mixtures of these compounds, which are absorbent in the characteristic wavelength range of the laser to be used and are thus capable of generating local heating in the plastic matrix in which they are embedded, which leads to melting of the plastic material.

Nanoscale is to be understood in that the largest dimension of the discrete laser-sensitive particles is smaller than 1 μm, i.e., in the nanometer range. In this case, this size definition relates to all possible particle morphologies such as primary particles and possible aggregates and agglomerates.

The particle size of the laser-sensitive particles is preferably 1 to 500 nm and particularly 5 to 100 nm. If the particle size is selected below 100 nm, the metal oxide particles are no longer visible per se and do not impair the transparency of the plastic matrix.

In the plastic material, the content of laser-sensitive particles is expediently 0.0001 to 0.1 weight-percent, preferably 0.001 to 0.01 weight-percent, in relation to the plastic material. A sufficient laser weldability of the plastic matrix is typically caused in this concentration range for all plastic materials coming into consideration.

If the particle size and concentration are selected suitably in the range specified, even with high-transparency matrix materials, impairment of the intrinsic transparency is prevented. It is thus expedient to select the lower concentration range for laser-sensitive pigments having particle sizes above 100 nm, while higher concentrations may also be selected for particle sizes below 100 nm.

Doped indium oxide, doped tin oxide, doped antimony oxide, and lanthanum hexaboride preferably come into consideration as the nanoscale laser-sensitive particles for manufacturing transparent, translucent, or opaque laser-weldable plastic materials that are tinted by colorants.

Especially suitable laser-sensitive additives are indium-tin oxide (ITO) or antimony-tin oxide (ATO) as well as doped indium-tin and/or antimony-tin oxide. Indium-tin oxide is especially preferred and in turn the “blue” indium-tin oxide obtainable through a partial reduction process. The non-reduced “yellow” indium-tin oxide may cause a visually perceivable slightly yellowish tint of the plastic material at higher concentrations and/or particle sizes in the upper range, while the “blue” indium-tin oxide does not lead to any perceivable color change.

The laser-sensitive particles to be used according to the present invention are known per se and are commercially available even in nanoscale form, i.e., as discrete particles having sizes below 1 μm and particularly in the size range preferred here, typically in the form of dispersions or in the form of easily redispersible powdered agglomerates of nanoscale particles.

The laser-sensitive particles are typically provided as agglomerated particles, for example, as agglomerates whose particle size may be from 1 μm to multiple millimeters. These may be incorporated into the plastic matrix with strong shear using the method according to the present invention, through which the agglomerates are broken down into the nanoscale primary particles.

The determination of the degree of agglomeration is performed in accordance with DIN 53206 (of August 1972).

Nanoscale particles, such as metal oxides in particular, may be manufactured, for example, through pyrolytic methods. Such methods are described, for example, in EP 1 142 830 A, EP 1 270 511 A, or DE 103 11 645. Furthermore, nanoscale particles may be manufactured through precipitation methods, as described in DE 100 22 037, for example.

The nanoscale laser-sensitive particles may be incorporated into practically all plastic systems in order to provide them with laser weldability. Plastic materials in which the plastic matrix is based on poly(meth)acrylate, polyamide, polyurethane, polyolefins, styrene polymers and styrene copolymers, polycarbonate, silicones, polyimides, polysulfone, polyethersulfone, polyketones, polyetherketones, PEEK, polyphenylene sulfide, polyester (such as PET, PEN, PBT), polyethylene oxide, polyurethane, polyolefins, or polymers containing fluorine (such as PVDF, EFEP, PTFE) are typical. Incorporation into blends, which contain the above-mentioned plastics as components, or into polymers derived from these classes, which were changed through subsequent reactions, is also possible. These materials are known and commercially available in manifold forms. The advantage according to the present invention of the nanoscale particles particularly comes to bear in colored transparent or translucent plastic systems such as polycarbonate, transparent polyamides (such as Grilamid® TR55, TR90, Trogamid® T5000, CX7323), polyethylene terephthalate, polysulfone, polyethersulfone, cycloolefin copolymers (Topas®, Zeonex®), polymethyl methacrylate, and their copolymers, since they do not influence the transparency of the material. Furthermore, transparent polystyrene and polypropylene are to be cited, as well as all partially crystalline plastics which may be processed into transparent films or molded bodies by using nucleation agents or special processing conditions. Furthermore, tinted opaque plastics may be equipped with the nanoscale laser-sensitive pigments.

The polyamides are generally manufactured from the following components: branched and unbranched aliphatic (6 through 14 C atoms), alkyl-substituted or unsubstituted cycloaliphatic (14 through 22 C atoms), araliphatic diamines (C14-C22), and aliphatic and cycloaliphatic dicarboxylic acids (C6 through C44); the latter may be partially replaced by aromatic dicarboxylic acids. In particular, the transparent polyamides may additionally be composed from monomer components having 6 C atoms, 11 C atoms, and/or 12 C atoms, which are derived from lactams or ω-amino carboxylic acids.

Preferably, but not exclusively, the transparent polyamides according to the present invention are manufactured from the following components: laurin lactam or ω-amino dodecanoic acid, azelaic acid, sebacic acid, dodecanoic diacid, fatty acids (C 18-C 36; e.g., under the trade name Pripol®), cyclohexane dicarboxylic acids, with partial or complete replacement of these aliphatic acids by isoterephthalic acid, terephthalic acid, naphthalene dicarboxylic acid, tributyl isophthalic acid. Furthermore decane diamine, dodecane diamine, nonane diamine, hexamethylene diamine in unbranched, branched, or substituted forms, as well as representatives from the class of alkyl-substituted/unsubstituted cycloaliphatic diamines bis-(4-aminocyclohexyl)-methane, bis-(3-methyl-4-aminocyclohexyl)-methane, bis-(4-aminocyclohexyl)-propane, bis-(aminocyclohexane), bis-(aminomethyl)-cyclohexane, isophorone diamine or even substituted pentamethylendiamines may be used.

Examples of corresponding transparent polyamides are described, for example, in EP 0 725 100 and EP 0 725 101.

Colored transparent, translucent, or opaque plastic systems based on polymethyl methacrylate, bisphenol-A-polycarbonate, polyamide, and cycloolefin copolymers made of norbornene and α-olefins are especially preferred, which may be made laser-weldable with the aid of the nanoscale particles according to the present invention, without impairing the color and transparency of the material.

In colored transparent, translucent, and opaque systems, the neutral intrinsic color of these nanoscale laser-sensitive additives is advantageous, since a free color selection is made possible for the plastic materials.

Those colorings which have only a slight intrinsic absorption in the range of interest between 800 and 1500 nm, i.e., are laser transparent, come into consideration.

To identify the colorants, in the following the nomenclature of the color index (C.I.) is used. All colorant names such as solvent orange or pigment red 101 are C.I. names. (For the sake of simplicity, the name component C.I. is left out in the following Table 1.)

TABLE 1
laser-transparent colorants

| | Preferred | Especially preferred |
|---|---|---|
| | concentration | concentration |
| Colorant C.I. | weight-percent | weight-percent |
| pigment orange 64 | 0.01-0.5 | 0.015-0.05 |
| solvent orange 60 | 0.01-1.0 | 0.01-0.5 |
| solvent orange 106 | 0.01-1.0 | 0.01-0.5 |
| solvent orange 111 | 0.01-1.0 | 0.01-0.5 |
| pigment red 48 | 0.05-1.0 | 0.05-0.5 |
| pigment red 101 | 0.005-0.5 | 0.01-0.3 |
| pigment red 144 | 0.005-0.5 | 0.01-0.2 |
| pigment red 166 | 0.005-0.5 | 0.01-0.2 |
| pigment red 178 | 0.01-1.0 | 0.03-0.5 |
| pigment red 254 | 0.01-1.0 | 0.03-0.5 |
| solvent red 52 | 0.01-1.0 | 0.01-0.5 |
| solvent red 111 | 0.01-1.0 | 0.01-0.5 |
| solvent red 135 | 0.01-1.0 | 0.01-0.5 |
| solvent red 179 | 0.01-1.0 | 0.01-0.5 |
| pigment green 7 | 0.0005-1.0 | 0.0005-0.5 |
| pigment green 17 | 0.01-1.0 | 0.03-0.5 |
| pigment green 50 | 0.005-0.5 | 0.005-0.05 |
| solvent green 3 | 0.01-1.0 | 0.01-0.5 |
| solvent green 20 | 0.01-1.0 | 0.01-0.5 |
| pigment blue 15 | 0.005-1.0 | 0.01-0.5 |
| pigment blue 29 | 0.02-5.0 | 0.2-2.0 |
| pigment blue 36 | 0.015-0.5 | 0.015-0.25 |
| pigment yellow 93 | 0.1-1.0 | 0.1-0.5 |
| pigment yellow 110 | 0.01-1.0 | 0.03-0.5 |
| pigment yellow 150 | 0.0005-0.5 | 0.0005-0.25 |
| pigment yellow 180 | 0.01-1.0 | 0.03-0.5 |
| pigment yellow 184 | 0.005-0.5 | 0.005-0.25 |
| solvent yellow 21 | 0.005-0.5 | 0.005-0.5 |
| solvent yellow 93 | 0.005-1.0 | 0.005-0.5 |
| pigment brown 24 | 0.005-0.5 | 0.005-0.15 |
| pigment violet 19 | 0.01-1.0 | 0.03 0.5 |
| pigment violet 13 | 0.01-1.0 | 0.01-0.5 |
| pigment violet 46 | 0.01-1.0 | 0.01-0.5 |

Some of the colorants cited may exist in different structures which differ slightly from one another. For example, pigments may be pigmented using different metal ions, through which different forms of the pigment arise. This forms are identified according to C.I. by suffixing a colon and a number, e.g., pigment red 48 for the pigment pigmented using sodium, pigment red 48:1 pigmented using calcium, pigment red 48:2 pigmented using barium, pigment red 48:3 pigmented using strontium, and pigment red 48:4 pigmented using magnesium. The C.I. colorant names cited here are to be understood in such a way that they comprise all forms and/or structures. They are recorded in the color index.

The laser-weldable plastic materials according to the present invention are typically provided as molded bodies or semifinished products. Laser-weldable lacquer coatings are also possible.

The manufacture of the high-transparency laser-weldable plastic materials according to the present invention is performed in a way known per se according to techniques and methods that are well-known and typical in plastic manufacturing and processing. In this case, it is possible to introduce the laser-sensitive additive into individual reactants or reactant mixtures before or during the polymerization or polycondensation or even to admix it during the reaction, the specific manufacturing method for the relevant plastics known to those skilled in the art being used. In the case of polycondensates such as polyamides, the additive may be incorporated into one of the monomer components, for example. This monomer component may then be subjected to a polycondensation reaction in a typical way with the remaining reaction partners. Furthermore, after formation of macromolecules, the resulting high molecular weight intermediate or final products may be admixed with the laser-sensitive additives, all methods well-known to those skilled in the art able to be used in this case as well.

Depending on the formulation of the plastic matrix material, fluid, semifluid, and solid formulation components or monomers as well as possibly necessary additives such as polymerization initiators, stabilizers (such as UV absorbers, heat stabilizers), visual brighteners, antistatic agents, softeners, demolding agents, lubricants, dispersing agents, antistatic agents, but also fillers and reinforcing agents or impact resistance modifiers are mixed and homogenized in devices and systems typical for this purpose, such as reactors, stirring vessels, mixers, roller mills, extruders, etc., possibly shaped, and then caused to cure. The nanoscale laser-sensitive particles are introduced into the material at the suitable instant for this purpose and incorporated homogeneously. The incorporation of the nanoscale laser-sensitive particles in the form of a concentrated pre-mixture (masterbatch) with the identical or a compatible plastic material is especially preferred.

It is advantageous if the incorporation of the nanoscale laser-sensitive particles into the plastic matrix is performed with high shear in the plastic matrix. This may be performed through appropriate setting of the mixters, roller mills, and extruders. In this way, any possible agglomeration or aggregation of the nanoscale particles into larger units may be effectively prevented; any existing larger particles are broken down. The corresponding technologies and the particular method parameters to be selected are well-known to those skilled in the art.

Plastic molded bodies and semifinished products are obtainable from the monomers and/or pre-polymers through injection molding or extruding from molding compounds or through casting methods.

The polymerization is performed through methods known to those skilled in the art, for example, by adding one or more polymerization initiators and inducing the polymerization through heating or irradiation. For complete conversion of the monomer(s), a tempering step may follow the polymerization.

Laser-weldable lacquer coatings are obtainable through dispersion of laser-sensitive oxides in typical lacquer formulations, coating, and drying or hardening of the lacquer layer.

The group of suitable lacquers comprises, for example, powder lacquers, physically drying lacquers, radiation-curable lacquers, single-component or multicomponent reactive lacquers, such as two-component polyurethane lacquers.

After plastic molded parts or lacquer coatings are manufactured from the plastic materials containing nanoscale laser-sensitive particulate solids, they may be welded through irradiation using laser light.

The laser welding may be performed on a commercially available laser marking device, such as a laser from Baasel, Type StarMark SMM65, having an output between 0.1 and 22 amperes and an advance speed between 1 and 100 mm/seconds. When setting the laser energy and advance speed, it is to be ensured that the output is not selected too high and the advance speed is not selected too low, in order to avoid undesired carbonization. At too low an output and too high an advance speed, the welding may be inadequate. The required settings may also be determined in the individual case for this purpose without anything further.

For welding plastic molded bodies or plastic semifinished products, it is necessary that at least one of the parts to be joined comprises plastic material according to the present invention at least in the surface region, the join surface being irradiated with laser light to which the metal oxide contained in the plastic material is sensitive. The method is expediently performed so that the join part facing toward the laser beam does not absorb the laser energy and the second join part is made of the plastic material according to the present invention, through which the parts are so strongly heated at the phase boundary that both parts are welded to one another. A certain contact pressure is necessary in order to obtain a material bond.

### EXAMPLE 1

Manufacture of a Colored-Transparent, Colored-Translucent, or Opaque Tinted Laser-Sensitive Molded Body

A colored-transparent, colored-translucent, or opaque tinted plastic molding compound, containing a laser-sensitive nanoscale pigment, was melted in an extruder and injected into an injection mold to form plastic molded bodies in the form of lamina or extruded to form slabs, films, or tubes.

The incorporation of the laser-sensitive pigment into the plastic molding compound was performed with strong shear in order to break down possible agglomerated particles into nanoscale primary particles.

Manufacture of the laser-absorbent (^{a}) molding compounds:

### Embodiment A^{a}

Trogamid® CX 7323, a commercial product of Degussa AG, high performance polymers branch, Marl, was used as the plastic molding compound and compounded and granulated on a Berstorff ZE 25 33 D extruder at 300° C. with nanoscale indium-tin oxide Nano®ITO IT-05 C5000 from Nanogate as the laser-sensitive pigment in a concentration of 0.01 weight-percent and with C.I. pigment red 166 (Scarlett RN, from Ciba Spezialitätenchemie) as the laser-transparent colorant in a concentration of 0.01 weight-percent.

### Embodiment B^{a}

Vestamid L1901, a commercial product of Degussa AG, high performance polymers branch, Marl, was used as the plastic molding compound and compounded and granulated on a Berstorff ZE 25 33 D extruder at 260° C. with nanoscale indium-tin oxide Nano®ITO IT-05 C5000 from Nanogate as the laser-sensitive pigment in a concentration of 0.01 weight-percent and with C.I. pigment red 166 (Scarlett RN, from Ciba Spezialitätenchemie) as the laser-transparent colorant in a concentration of 0.01 weight-percent.

### Embodiment Ca

Vestamid L1901, a commercial product of Degussa AG, high performance polymers branch, Marl, was used as the plastic molding compound and compounded and granulated on a Berstorff ZE 25 33 D extruder at 260° C. with nanoscale indium-tin oxide Nano®ITO IT-05 C5000 from Nanogate as the laser-sensitive pigment in a concentration of 0.01 weight-percent and with C.I. pigment green 7 (Irgalite Green FNP, from Ciba Spezialitätenchemie) as the laser-transparent colorant in a concentration of 0.01 weight-percent.

### Embodiment D^{a}

Plexiglas® 7N, a commercial product of Degussa AG, methacrylates branch, Darmstadt, was used as the plastic molding compound. Nanoscale indium-tin oxide Nano®ITO IT-05 C5000 from Nanogate as the laser-sensitive pigment in a concentration of 0.01 weight-percent was compounded and granulated on a Berstorff ZE 25 33 D extruder at 250° C. with C.I. pigment red 166 (Scarlett RN, from Ciba Spezialitätenchemie) as the laser-transparent colorant in a concentration of 0.01 weight-percent. In the case of extrusion, a higher molecular weight molding compound of the type Plexiglas® 7H may advantageously also be used.

### Embodiment Ea

Plexiglas® 7N, a commercial product of Degussa AG, methacrylates branch, Darmstadt, was used as the plastic molding compound. Nanoscale indium-tin oxide Nano®ITO IT-05 C5000 from Nanogate as the laser-sensitive pigment in a concentration of 0.01 weight-percent was compounded and granulated on a Berstorff ZE 25 33 D extruder at 250° C. with C.I. pigment blue 29 (ultramarine blue) as the laser-transparent colorant in a concentration of 0.01 weight-percent. In the case of extrusion, a higher molecular weight molding compound of the type Plexiglas® 7H may advantageously also be used.

### Embodiment F^{a}

Plexiglas® 7N, a commercial product of Degussa AG, methacrylates branch, Darmstadt, was used as the plastic molding compound. Nanoscale indium-tin oxide Nano®ITO IT-05 C5000 from Nanogate as the laser-sensitive in a concentration of 0.01 weight-percent pigment was compounded and granulated on a Berstorff ZE 25 33 D extruder at 250° C. with C.I. pigment green 7 (Irgalite Green FNP, from Ciba Spezialitätenchemie) as the laser-transparent colorant in a concentration of 0.01 weight-percent. In the case of extrusion, a higher molecular weight molding compound of the type Plexiglas® 7H may advantageously also be used.

The manufacture of the corresponding laser-transparent (^{t}) molding compounds A^{t} through F^{t} was performed in accordance with the above embodiments A^{a} through F^{a}, but with the difference that no laser-sensitive pigment was added.

### EXAMPLE 2

Manufacture of a Colored-Transparent, Colored-Translucent, or Opaque Tinted Laser-Sensitive Cast PMMA Semifinished Product

The nanoscale indium-tin oxide Nano®ITO IT-05 C5000 from Nanogate was dispersed in a concentration of 0.001 weight-percent as the laser-sensitive pigment in a concentration of 0.01 weight-percent, together with dispersants and colorants, in 1000 parts PMMA/MMA pre-polymer solution having a viscosity of 1000 cP. After adding 1 part AIBN, the mixture was poured into a chamber and polymerized at 50° C. in the water bath for 2.5 hours. Through subsequent tempering at 115° C. in the drying cabinet, the remaining monomers were converted. A laser-absorbent semifinished product was obtained.

To produce a laser-transparent semifinished product, the batch was manufactured without laser-sensitive pigment.

If a transparent semifinished product is to be produced, a soluble colorant from the table (name “solvent”) is preferably used. Weakly scattering micronized colorant pigments, such as ultramarine blue, may be used for nearly transparent settings. More strongly scattering pigments are suitable for translucent or opaque variations. The assignment of the colorant is known to those skilled in the art. Examples and instructions for polymerization are specified in, among other things, DE 43 139 24.

Variant A

C.I. pigment red 166 (Scarlett RN, from Ciba Spezialitätenchemie) was used in a concentration of 0.01 weight-percent as the laser-transparent colorant.

Variant B

C.I. pigment blue 29 (ultramarine blue, from Ciba Spezialitätenchemie) was used in a concentration of 0.01 weight-percent as the laser-transparent colorant.

Variant C

C.I. pigment green 7 (Irgalite Green GFNP, from Ciba Spezialitätenchemie) was used in a concentration of 0.01 weight-percent as the laser-transparent colorant.

### EXAMPLE 3

Performing Laser Welding

(Cast PMMA having 0.01 Weight-Percent ITO Content)

A colored-transparent, colored-translucent, or opaque tinted laser-sensitive plastic slab (dimensions 60 mm*60 mm*2 mm) made of cast PMMA having an ITO content of 0.01 weight-percent was brought into contact with a second plastic slab made of undoped cast PMMA, which was colored-transparent, colored-translucent, or opaque tinted in the visible range of light but laser-transparent, using the faces to be welded. The slabs were laid into the welding support of the Starmark laser SMM65 from Baasel-Lasertechnik in such a way that the undoped slab laid on top, i.e., was first penetrated by the laser beam. The focus of the laser beam was set to the contact face of the two slabs. The parameters frequency (2250 Hz), lamp current (22.0 A), and advance speed (30 mm/seconds) were set on the control unit of the laser. After the size of the area to be welded was input (22*4 mm²), the laser was started. At the end of the welding procedure, the welded plastic slabs could be removed from the device.

Adhesion values having the grade 4 were achieved in the hand test.

The adhesion was evaluated as follows:
0 no adhesion.
1 slight adhesion.
2 some adhesion; to be separated with little trouble.
3 good adhesion; only to be separated with great trouble and possibly with the aid of tools.
4 inseparable adhesion; separation only through cohesion fracture.

### Embodiment A

Molding Compound A^{a} with Molding Compound A^{t}

A standard injection molded plastic slab (dimensions 60 mm*60 mm*2 mm) made of molding compound A^{a} was brought into contact with a second standard injection molded plastic slab (dimensions 60 mm*60 mm*2 mm) made of molding compound A^{t}. The slabs were laid into the welding support of the Starmark laser SMM65 from Baasel-Lasertechnik in such a way that the slab made of molding compound A^{t} laid on top, i.e., was first penetrated by the laser beam. The parameters frequency (2250 Hz), lamp current (22.0 A), and advance speed (10 mm/seconds) were set on the control unit of the laser. After the size of the area to be welded was input (22*4 mm²), the laser was started. At the end of the welding procedure, the welded plastic slabs could be removed from the device.

Adhesion values having the grade 4 were achieved in the hand test.

Variant A1:

Pigment blue 29 (ultramarine blue) was used as the colorant in the plastic.

Adhesion values having the grade 4 were achieved in the hand test.

Variant A2:

Solvent orange 60 was used as the colorant in the plastic. Adhesion values having the grade 4 were achieved in the hand test.

### Embodiment B

Molding Compound B^{a} with Molding Compound B^{t}

A standard injection molded plastic slab (dimensions 60 mm*60 mm*2 mm) made of molding compound B^{a} was brought into contact with a second standard injection molded plastic slab (dimensions 60 mm*60 mm*2 mm) made of molding compound B^{t}. The slabs were laid into the welding support of the Starmark laser SMM65 from Baasel-Lasertechnik in such a way that the slab made of molding compound B^{t} laid on top, i.e., was first penetrated by the laser beam. The parameters frequency (2250 Hz), lamp current (22.0 A), and advance speed (10 mm/seconds) were set on the control unit of the laser. After the size of the area to be welded was input (22*4 mm²), the laser was started. At the end of the welding procedure, the welded plastic slabs could be removed from the device.

Adhesion values having the grade 4 were achieved in the hand test.

### Embodiment C

Molding Compound C^{a} with Molding Compound C^{t}

A standard injection molded plastic slab (dimensions 60 mm*60 mm*2 mm) made of molding compound C^{a} was brought into contact with a second standard injection molded plastic slab (dimensions 60 mm*60 mm*2 mm) made of molding compound C^{t}. The slabs were laid into the welding support of the Starmark laser SMM65 from Baasel-Lasertechnik in such a way that the slab made of molding compound C^{t} laid on top, i.e., was first penetrated by the laser beam. The parameters frequency (2250 Hz), lamp current (22.0 A), and advance speed (10 mm/seconds) were set on the control unit of the laser. After the size of the area to be welded was input (22*4 mm²), the laser was started. At the end of the welding procedure, the welded plastic slabs could be removed from the device.

Adhesion values having the grade 4 were achieved in the hand test.

### Embodiment D

Molding Compound D^{a} with Molding Compound D^{t}

A standard injection molded plastic slab (dimensions 60 mm*60 mm*2 mm) made of molding compound D^{a} was brought into contact with a second standard injection molded plastic slab (dimensions 60 mm*60 mm*2 mm) made of molding compound D^{t}. The slabs were laid into the welding support of the Starmark laser SMM65 from Baasel-Lasertechnik in such a way that the slab made of molding compound D^{t} laid on top, i.e., was first penetrated by the laser beam. The parameters frequency (2250 Hz), lamp current (22.0 A), and advance speed (10 mm/seconds) were set on the control unit of the laser. After the size of the area to be welded was input (22*4 mm²), the laser was started. At the end of the welding procedure, the welded plastic slabs could be removed from the device.

Adhesion values having the grade 4 were achieved in the hand test.

### Embodiment E

Molding Compound E^{a} with Molding Compound E^{t}

The welding was performed analogously to the welding of molding compound D^{a} with molding compound D^{t}.

Adhesion values having the grade 4 were achieved in the hand test.

### Embodiment F

Molding Compound D^{a} with Molding Compound D^{t}

The welding was performed analogously to the welding of molding compound D^{a} with molding compound D^{t}.

Adhesion values having the grade 4 were achieved in the hand test.

1-17. (canceled)

18. A plastic material comprising nanoscale laser-sensitive particles that render said plastic material laser weldable, wherein said plastic material is transparent, translucent, or opaque and is tinted by colorant.

19. The plastic material of claim 18, wherein said laser-sensitive particles are 1 to 500 nm in diameter.

20. The plastic material of claim 19, wherein said laser-sensitive particles are 5 to 100 nm in diameter.

21. The plastic material of claim 19, wherein the content of laser-sensitive particles is 0.0001 to 0.1 weight-percent, relative to the plastic material.

22. The plastic material of claim 21, wherein the content of laser-sensitive particles is 0.001 to 0.01 weight-percent, relative to the plastic material.

23. The plastic material of claim 18, wherein said laser-sensitive particles comprise one or more compounds selected from the group consisting of: metal oxides; mixed metal oxides; complex oxides; metal sulfides; borides; phosphates; carbonates; sulfates; and nitrides.

24. The plastic material of claim 23, wherein said laser-sensitive particles comprise one or more compounds selected from the group consisting of: doped indium oxide, doped tin oxide, doped antimony oxide, indium-zinc oxide, and lanthanum hexaboride.

25. The plastic material of claim 24, wherein said laser-sensitive particles comprise indium-tin oxide or antimony-tin oxide.

26. The plastic material of claim 25, wherein said laser-sensitive particles comprise blue indium-tin oxide.

27. The plastic material of claim 18, wherein said plastic material comprises a matrix of one or more compounds selected from the group consisting of: poly(meth)acrylate; polyamide; polyurethane; polyolefins; styrene polymers and styrene copolymers; polycarbonate; silicones; polyimides; polysulfone; polyethersulfone; polyketones; polyetherketones; polyphenylene sulfide; polyester; polyethylene oxide; polyurethane; polyolefins; cycloolefin copolymers; and polymers containing fluorine.

28. The plastic material of claim 27, wherein said plastic material comprises a matrix of polymethyl methacrylate.

29. The plastic material of claim 27, wherein said plastic material comprises a matrix of bisphenol-A-polycarbonate.

30. The plastic material of claim 27, wherein said plastic material comprises a matrix of polyamide.

31. The plastic material of claim 18, wherein said plastic material is in the form of a molded body, semifinished product, or lacquer coating.

32. A method for manufacturing a transparent, translucent, or opaque laser-weldable plastic material that is tinted by a colorant, comprising:
a) mixing nanoscale laser-sensitive particles into a plastic matrix or a fluid monomer-containing casting formulation under conditions of high shear;
b) forming said plastic material from said plastic matrix or casting formulation.

33. The method of claim 32, wherein said nanoscale laser-sensitive particles are incorporated into said plastic matrix or said fluid monomer-containing casting formulation as a concentrated pre-mixture.

34. A method for joining together parts of a plastic molded body or semifinished product wherein at least one of the parts to be joined comprises the plastic material of claim 1 at least in the surface region of the joining area, said method comprising irradiating said joining area with laser light to which the particles contained in the plastic material are sensitive.

35. The plastic material of claim 18, wherein:
a) said laser-sensitive particles are 1 to 500 nm in diameter;
b) the content of said laser-sensitive particles is 0.0001 to 0.1 weight-percent, relative to the plastic material;
c) said laser-sensitive particles comprise one or more compounds selected from the group consisting of: doped indium oxide; doped tin oxide; doped antimony oxide; indium-zinc oxide; and lanthanum hexaboride; and
d) said plastic material comprises a matrix of one or more compounds selected from the group consisting of: poly(meth)acrylate; polyamide; polyurethane; polyolefins; styrene polymers and styrene copolymers; polycarbonate; silicones; polyimides; polysulfone; polyethersulfone; polyketones; polyetherketones; polyphenylene sulfide; polyester; polyethylene oxide; polyurethane; polyolefins; cycloolefin copolymers; and polymers containing fluorine.

36. The plastic material of claim 35, wherein:
a) said laser-sensitive particles are 5 to 100 nm in diameter;
b) the content of laser-sensitive particles is 0.001 to 0.01 weight-percent, relative to the plastic material.

37. The plastic material of claim 36, wherein:
a) said laser-sensitive particles comprise indium-tin oxide or antimony-tin oxide; and
b) said plastic material comprises a matrix of polymethyl methacrylate, bisphenol-A-polycarbonate, or polyamide.
